(19) United States
(12) Patent Application Publication
(10) Pub. No.: US 2005/0138979 A1
(43) Pub. Date: Jun. 30, 2005

(54) Method for producing grandular fertilisers

(76) Inventor: Vladimir Vasillievich Minaev, Moscow (RU)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/504,900

(22) PCT Filed: Feb. 18, 2003
(86) PCT No.: PCT/EP03/01593

(30) Foreign Application Priority Data
Feb. 18, 2002 (EP) 02003715.6

(51) Int. Cl. C05G 5/00

(52) U.S. Cl. 71/64.03

(57) ABSTRACT

There is provided a method for producing granular fertilisers that includes at least one structural compound based on at least two salts. The method includes the steps of disposing of at least one salt that includes nitrogen, humidifying the at least one salt, mixing the at least one humidified salt with at least one substance comprising at least one alkaline and/or alkaline-earth element and/or at least one element of group IV, producing a granular fertiliser by granulation of the mixture, and cooling the granular fertiliser. There is also provided a granular fertiliser comprising nitrogen and having a pH in the range of 3≦pH≦7. The granular fertiliser shows a strength σ of σ≧3 MPa and includes a concentration c_{SC} of at least one structural compound with c_{SC}≧50 wt.-%.

The invention relates to a method for producing granular fertilisers comprising structural compounds based on at least one salt according to the preamble of claims 1 or 13. Further, the invention relates to a granular fertiliser according to the preamble of claim 34.

In particular, for producing complex granular fertilisers to be used in the agriculture a broad assortment of fertilisers has to be provided depending on the given usage conditions.

According to one known method for producing complex granular fertilisers, first, a mixture of starting materials is obtained. The starting material comprises usually ammonia. The mixture is then heated to a temperature when it starts to melt. The molten starting materials mixture is granulated in a further step. In consequence, a granular fertiliser is produced. The obtained fertiliser is then cooled, classified and packed.

Drawbacks of the method mentioned above are, first, a possible ammonia evolution into a gas phase. Further, the technological set-up becomes complex due to the necessity to use initial components only as solids and the impossibility of return of absorbing solutions into the process. Such a method is described for example in the article “Obtaining of NPK-fertilisers from ammonia phosphate and urea with added micro elements” of E. Aasamae, E. Arumeel and M. Eeinard in Proc. Est. Acad., Chem.—1992, 41, N4 pp. 164-168.

According to another method of producing complex granular fertilisers, a mixture of the starting material with a humidity of 3 to 10 wt.-% is granulated in the presence of alkaline, alkaline-earth elements and elements of group IV of the periodic system taken in an amount of 0.3 to 6 wt.-% recalculated for elements (B. P. Sobolev, “Method of preparation of granular fertilisers”, the application for the invention N 2000127782, priority from Aug. 11, 2000, Russia).

However, complex granular fertilisers produced according to known methods are strictly limited in view of the assortment range concerning losses of ammonia, fluorine and other substances into a gas phase. Therefore, cleaning the effluent gases in the process and return of the produced absorbing solutions into a technological process is necessary. As a result, the technological set-up becomes complicated and cumbersome. Further, a transition from production of one brand of fertilisers to another one requires solving complex technological problems.

In addition to technological problems, further requirements arise due to the product's properties. Some brands of fertilisers have a high hygroscopicity. This is especially true in cases with excess of nitrogen, or if carbamide is used. Moreover, such fertilisers are susceptible to strong consolidation. Therefore, serious disadvantages concerning the applicability arise.

Multiple salts produced by applying certain compositions of the fertiliser to be prepared during the production process essentially improve the physico-mechanical properties of the product. One reason for the advantage of the multiple salts is that they contribute to the formation of structural compounds. With the term “structural compounds” salts are named that can be different in composition but that can comprise the same substance. For example, water may be such substance that may be present in the crystal lattice of the salt.

However, according to the known methods it is impossible to reach a high enough extent of formation of structural compounds based on at least two salts to affect the range of issued production besides the physico-mechanical properties of the fertilisers.

A further negative result is the limitation of productivity. In addition, only a small discharge of ammonia into a gas phase takes place, which causes the necessity of using ammonia saltpetre only as a solution. Hence, the capability of obtaining fertilisers with increased concentration of nitrogen and further components is limited.

In view of the disadvantages given by known methods to produce granular fertilisers, mainly the following objects of the invention arise.

One problem to be solved by the invention is to produce much less limited assortment of granular fertilisers. Another problem to be solved is to lift limitations on the productivity of the technological process. Further, ecological parameters of the production line have to be improved.

Moreover, it is an object of the invention to improve the physico-mechanical properties of the fertilisers. It is a further object of the invention to increase the efficiency of the application of alkaline, alkaline earth-elements and group IV elements.

It is another object of the invention to provide for obtaining different brands of fertilisers in a broad range of ratios and concentrations of nutrient materials.

The above mentioned problems are solved by a method with the features of claims 1 or 13. Further, in claim 34, a granular fertiliser is provided which shows the objected properties. Advantages refinements are in each case given in properties. Advantages refinements are in each case given in the dependent claims.

The solution according to the invention provides for the first time a method for producing granular fertilisers comprising structural compounds based on at least two salts with the steps of disposing of at least one salt comprising nitrogen, humidifying the at least one salt, mixing the at lease one humidified salt with at least one substance comprising alkaline and/or alkaline-earth element and/or at least one element of group IV, producing a granular fertiliser by granulation of the mixture, and cooling the granular fertiliser.

One important advantage of the method is the efficient utilisation of substances based on alkaline, alkaline-earth elements and/or group IV elements. These elements form structural compounds based on at least two salts. Therefore, the method according to the invention provides for realising the desired physico-mechanical properties of the product in a surprisingly simple way.

The formation of structural compounds based on at least two salts is accompanied by heat evolution in the chemical process. The multiple salts produced in the exothermic chemical reaction provide for the great advantage of improving the physico-mechanical properties of the fertiliser. According to the invention, the process step of cooling gives possibility of adopting the method in a surprisingly simple way even to extremely different requirements.

To ensure a pre-defined size scale of the product, according to the invention the method further comprises the step of classification of the granular fertiliser. To run the process advantageously even more efficiently, the invention provides for feeding at least a part of the fine portion obtained by classification back into the process as a so-called recycle.

The method according to the invention allows to improve the physico-mechanical properties of the fertilisers in view of a low hygroscopicity and a minor chance of undergoing solidification. Further it is advantageously possible to adjust the ratio and concentration of nutrient elements in the produced fertilisers in a broad range.

Thus, lifting limitations on the product yield due to prevention of ammonia discharge and return of absorbing solutions into the process are lifted are possibly by means of the invention. In addition, advantageously the ecological safety of fertiliser production is increased.

Moreover, flexibility of the process in changing of the production from one brand of fertiliser to another one is provided by the advantageously simple technological scheme. In consequence, capital costs in construction of the production line and manufacturing service costs are reduced.

The granulation itself can be carried out by any known method. If the granulation is carried out in an drum granulator, then the steps of mixing, granulation and cooling may be combined in a single apparatus.

If the granulation, however, is carried out in a plate granulator, according to the invention the steps of mixing, granulation and cooling can also be carried out in different apparatuses. Already the steps of mixing and granulation can be superimposed by the chemical reaction of forming the granular fertiliser. The actual reaction, however, actively proceeds during the cooling step.

The method according to the invention provides for the great advantage of being flexible in view of the starting material. In particular, at least one further salt comprising nitrogen can be fed into the process. Preferably, the at least one salt comprising nitrogen and/or the at least one further salt comprising nitrogen comprise ammonium sulphate and/or ammonium phosphate and/or diammonium phosphate and/or ammonium saltpetre.

As explained above, according to the invention the advantageous physico-mechanical properties of the product are mainly achieved by forming structural compounds. In order to do so, the invention provides for the humidifying step. In particular, by humidifying the at least one salt comprising nitrogen and/or the at least one further salt comprising nitrogen, a solution and/or pulp of salt is produced.

Preferably, the concentration c of the solution and/or pulp comprising the at least one salt comprising nitrogen and/or the at least one further salt comprising nitrogen is equal or greater than 40 wt.-%. Preferably, the concentration c of the solution and/or pulp is in the range of 75 wt.-% ≦c≦95 wt.-%.

For realising the desired physico-mechanical properties of the fertiliser provided by the structural compounds, according to the invention adjusting of the humidity is one surprisingly simple possibility. Therefore, the invention advantageously provides a humidity φ_{SP} of the solution and/or pulp comprising the at least one salt comprising nitrogen in the range of 3 wt.-% ≦φ_{SP}≦30 wt.-%. In addition the invention provides a humidity φ_{S} of a salt being equal to or greater than 10 wt.-%.

On the contrary to known methods for producing granular fertilisers by melting the starting material, the method according to the invention provides for the possibility of reducing the process temperature significantly. In particular, the temperature [symbol] _{SP} of the solution and/or pulp comprising the at least one salt comprising nitrogen is in the range of 75° C.≦ [symbol] _{SP}≦95° C. Preferably, the temperature [symbol] _{SP} is in the range of 80° C.≦ [symbol] _{SP}≦85° C. Thus, the energy consumption can advantageously be significantly reduced in a process carried out according to the method of the invention.

The method according to the invention further allows to adopt the product to a broad range of pH values. In particular, the pH of the solution and/or pulp comprising the at least one salt comprising nitrogen is in the range of 1.5≦pH ≦8, preferably in the range of 4≦pH≦5.

The invention is not limited to the above described method for producing granular fertilisers starting with disposing of at least one salt comprising nitrogen and humidifying the at least one salt. Moreover, the invention also provides an alternative method for producing the fertilisers comprising at least one structural compound with the following steps: disposing of at least one mineral substance, de-composing the at least one mineral substance in particular by precipitation using an asset, separating the remaining acidic liquor from the precipitate, ammonising the remaining acidic liquor, adding at least one substance comprising at least one alkaline and/or alkaline-earth element and/or at least one element of the first period of group IV to the ammonised acidic liquor, evaporating the surplus of moisture, producing a granular fertiliser by granulation of the mixture, and cooling the granular fertiliser.

By providing the possibility of using a mineral substance as a starting material, the invention advantageously opens up the possibility of practically not being limited in the choice of the starting material.

The alternative method of carrying out the invention can also comprise the further step of classification of the granular fertiliser in order to ensure a predetermined size range of the product. Further, at least a part of the fine portion obtained by classification can be fed back into the process as recycle.

In particular, the at least one mineral substance can comprise apatite, which is in a surprisingly simple way

In general, in the method according to the invention the ratio M of the mass flow of recycle referred to the entire mass flow of the product is equal to or below 40 wt.-%. By controlling this parameter, the advantage of carrying out the whole process extremely efficiently is given.

The method of the invention is, further, not generally limited to the process steps mentioned above. In particular, single steps can be carried out more than once. In addition, the sequence of the process steps may be varied in any desired way.

In detail, the method according to the invention can comprise a first further step of mixing being carried out after adding the at least one substance comprising an alkaline and/or alkaline-earth element and/or at least one element of group IV.

Moreover, at least one further salt can be fed into the process. In particular, the at least one further salt comprises carbamide and/or potassium chloride and/or sodium chloride. Hence, further nutrients as well as further components forming the structural compounds can be fed into the process while a precise dosage and controlling of the mixture's properties are ensured by feeding several salts each in a single way.

To further contribute to the wide variety of ways to carry out the method according to the invention, a second further step of mixing can be carried out after feeding the at least one further salt into the process.

For optimising the conditions of forming granular fertilisers comprising the advantageous structural compounds, in the method according to the invention the temperature [symbol] _{G} during the granulation is in the range of 45° C.≦ [symbol] _{G}≦85° C., preferably in the range of 80° C.≦ [symbol] _{G}≦85° C.

Already during the production of the granular fertilisers, an increased consumption of moisture absorbed from environmental atmosphere into the structural components is possible. In particular, the substances based on alkaline, alkaline-earth and other elements for transformation undergo this consumption of moisture. Such an increased consumption of moisture has the disadvantage to at least partially counteract the solution provided by the invention which ensures improved physico-mechanical properties of the product.

Hence, the method according to the invention further provides an additional step of encapsulating the granular fertiliser and/or a further component. By doing so, especially stocking of the unpacked product can advantageously avoided.

Preferably, a further component to be encapsulated can be a granular component itself, in particular, prilled ammonium saltpetre and/or granulated carbamide. By encapsulating ammonium saltpetre and carbamide with the prepared solutions and/or pulps, the invention provides the great advantage of not only reducing hygroscopicity of these products, but also preventing ammonium saltpetre from inflammation and explosion.

In one embodiment of the invention, therefore, in the step of encapsulating the solutions and/or pulps to be mixed with at least one substance comprising an alkaline and/or alkaline-earth element and/or at least one element of group IV are used as a coating material.

To optimise the reliability of the process in view of forming the structural compounds, in the method according to the invention the cooling rate C is in the range of 0.1 K min⁻¹≦C≦40 K min⁻¹.

A further possibility provided by the method according to the invention is to feed at least one mineral acid into the process. In particular, the at least one mineral acid can comprise sulphuric acid and/or phosphoric acid and/or nitric acid. Preferably, the pH of the mixture obtained by feeding the at least one mineral acid into the process is controlled by the amount of mineral acid added.

In addition, a further possibility of designing the method according to the invention in view of the given requirements is to feed water into the process.

For example, granulation is carried out by means of humidifying, moistening, respectively, of mixed powder materials with solutions and/or pulps (slurries). Humidifying may for instance be carried out only with water. However, in this case a large amount of water may be needed resulting in a decrease of the concentrations of principle nutrient elements such as in particular N, P, and K.

Therefore, the preferred technological methods for preparing a humidifying agent comprise a preparation of concentrated solutions and/or pulps. The term “solution” refers to a solution of, for instance, ammonium saltpetre in water, or ammonium phosphate or ammonium sulphate in water, or ammonium saltpetre, ammonium phosphate, potassium chloride in water, or carbamide, ammonium phosphate in water and so on.

To cover an as wide as possible range of compositions of the produced granular fertiliser, in the method according to the invention a further step of adding at least one nutrient can be carried out. In particular, this nutrient can comprise calcium, magnesium, iron, sulphur, boron, zinc, copper, manganese, and molybdenum.

As explained above, the product strength depends on the cooling rate of the fertiliser after the granulation stage. Heat produced in the exothermic chemical reaction is dissipated by cooling. Hence, by cooling the formation of structural compounds is encouraged.

If the formation reaction of the structural compounds proceeds not completely during carrying out the process, the invention provides the possibility of storing the product after the production. In particular, the method according to the invention can comprise the further step of maturating the product. Preferably, the maturation time t_{M} is equal to or less than 72 hours.

The invention further provides a granular fertiliser in particular produced using a method as described above which comprises nitrogen and has a pH in the range 3=pH=7.

The granular fertiliser according to the invention shows a strength σ being equal to or greater than 3 MPa. The strength σ is the resistance to pressure. The granular fertiliser shows an entire amount c_{SC} of at least one structural component being equal to or greater than 50 wt.-%.

The concentration of the structural compounds is given in relation to the theoretical concentration. The theoretical concentration can be calculated according to a chemical formula of the structural compound. For example, as a structural compound (NH₄)₂SO₄MgSO₄ is produced. This structural compound should incorporate six water molecules. Hence, the quantity of moisture introduced into a process with solutions and/or pulps is known. After carrying out the process the concentration of free moisture in the product is determined. Accordingly, the quantity of the formed structural compounds can be calculated.

According to the invention, the structural compound is based on a multiple salt comprising one further substance, in particular water. As multiple salts comprising in particular water, structural compounds can comprise MgHPO₄nH₂O and/or NH₄MgPO₄nH₂O and/or (NH₄)₂SO₄Mg₂SO₄nH₂O and/or NH₄NaHPO₄nH₂O.

To provide further nutrient components, the granular fertiliser according to the invention further comprises P₂O₅ and/or K₂O and/or SO₃.

In particular, a granular fertiliser can comprise nitrogen in the range of 10 wt.-% ≦c_{N}≦27 wt.-% and. P₂O₅ in the range of 6 wt.-% ≦c_{P2O5}≦30 wt.-% and K₂O in the range of 6 wt.-% ≦c_{K2O}≦30 wt.-%.

The granular fertiliser according to the invention can alternatively comprise nitrogen in a concentration of c_{N}=30 wt.-% and P₂O₅ with a concentration of C_{P2O5}=5 wt.-%.

In a further alternative composition, the granular fertiliser can comprise nitrogen with a concentration of c_{N}=28 wt.-% and SO₃ with a concentration of c_{5O3}=3 wt.-%.

The invention is described below in view of preferred embodiments referring to the enclosed Figures.

The figures illustrate the following examples:

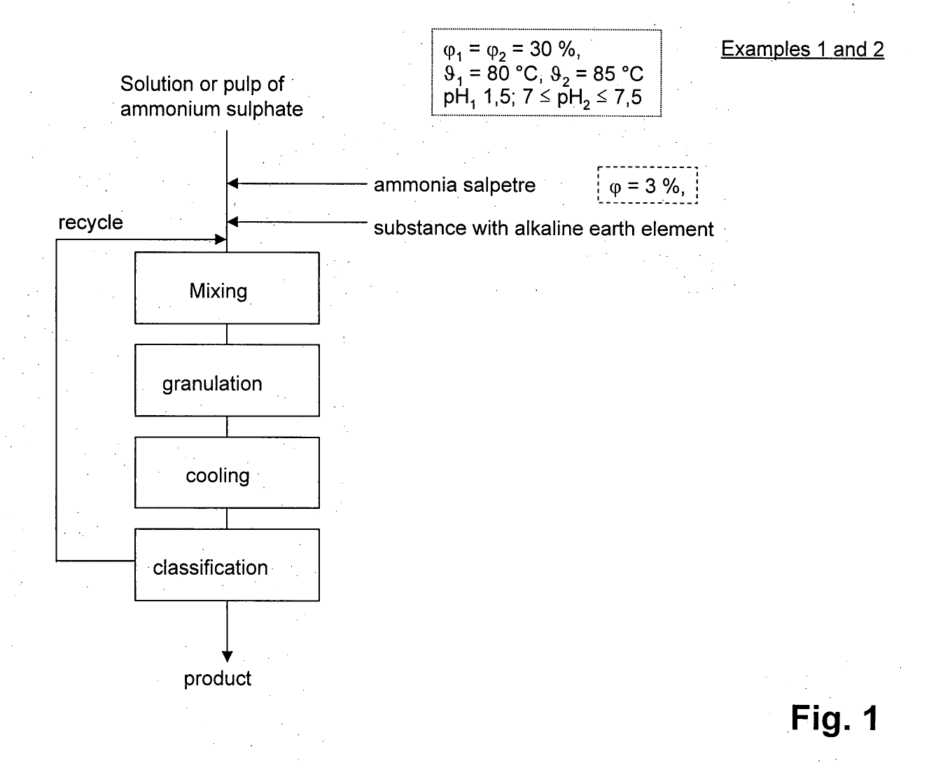

FIG. 1 one schematic flow chart of the method according to the invention realised in examples 1 and 2,

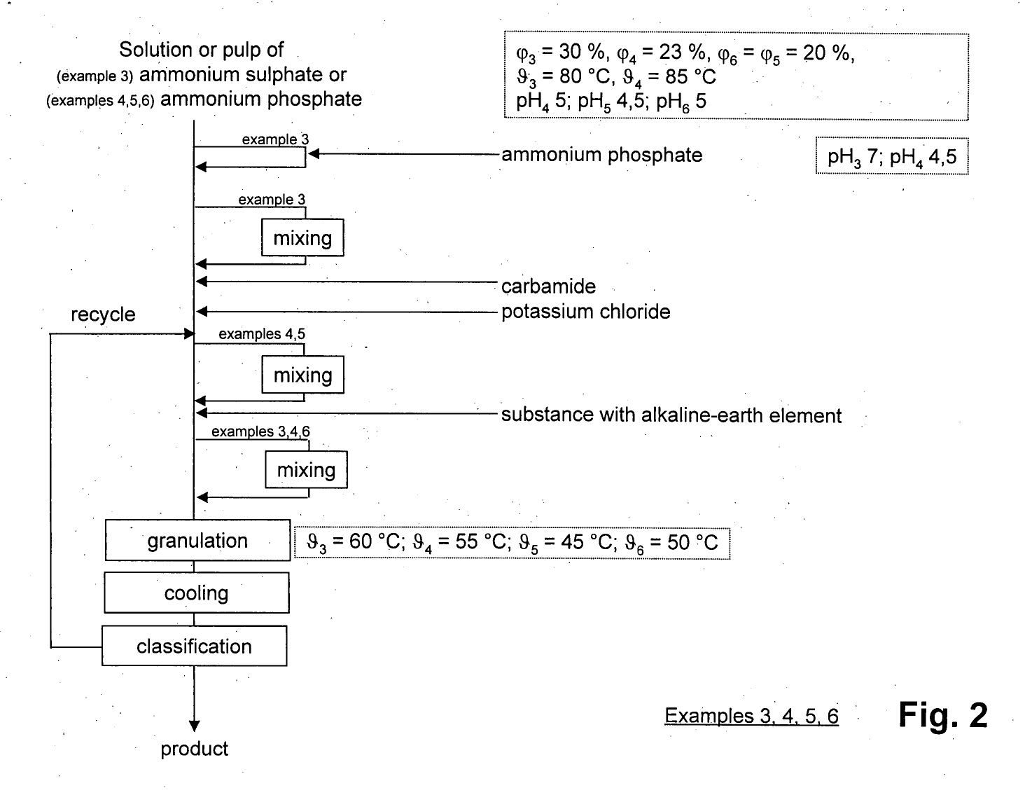

FIG. 2 one schematic flow chart of the method according to the invention realised in examples 3, 4, 5 and 6,

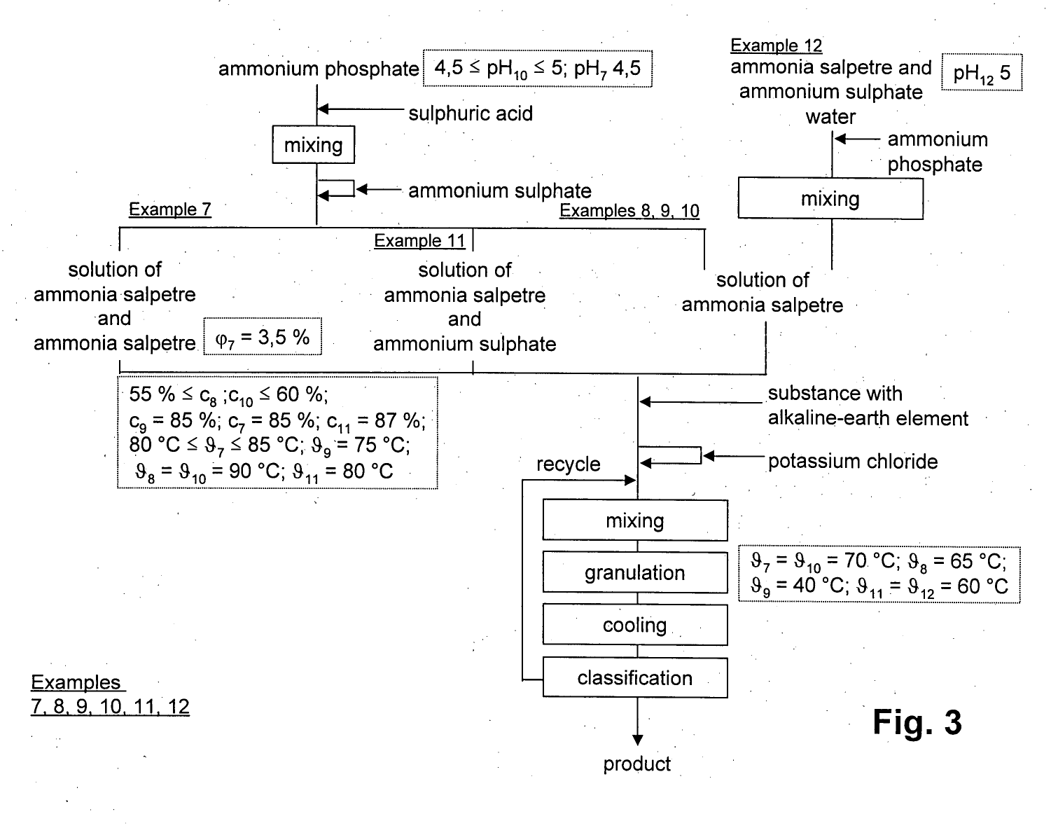

FIG. 3 one schematic flow chart of the method according to the invention realised in examples 7, 8, 9, 10, 11 and 12,

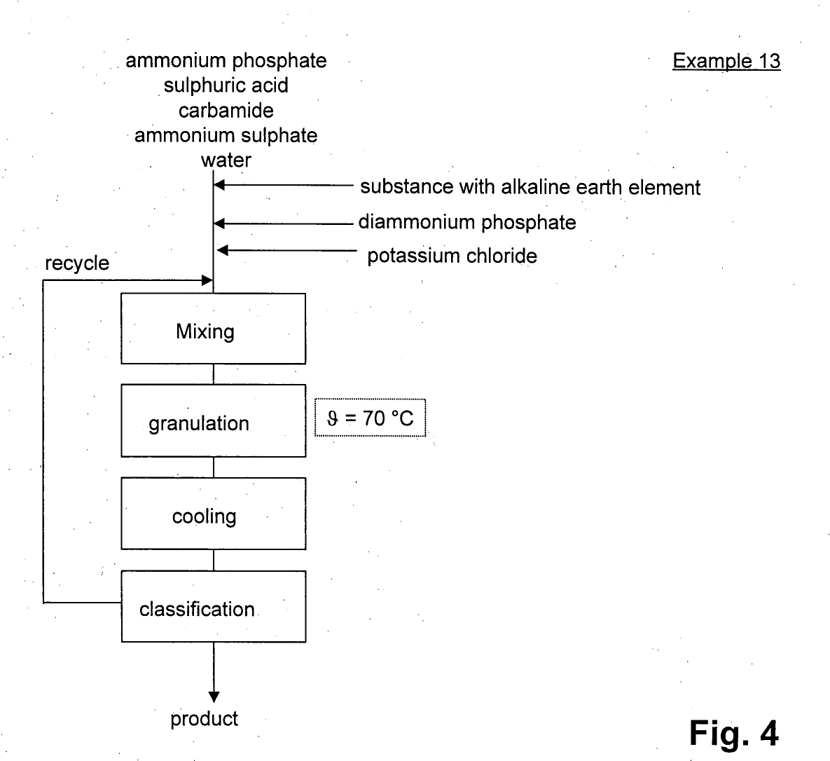

FIG. 4 one schematic flow chart of the method according to the invention realised in examples 13,

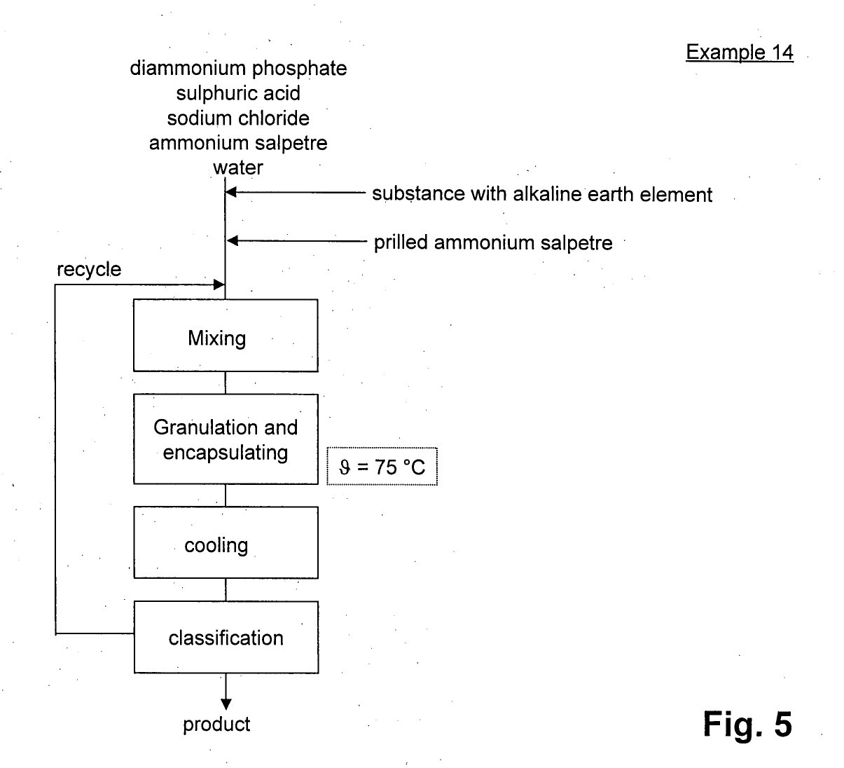

FIG. 5 one schematic flow chart of the method according to the invention realised in example 14,

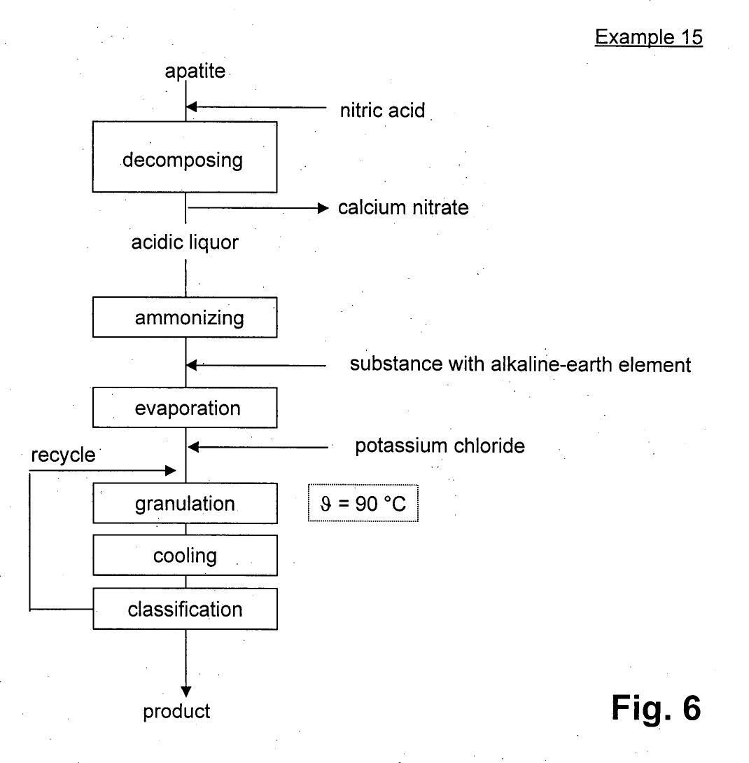

FIG. 6 one schematic flow chart of the method according to the invention realised in example 15.

Examples 1 and 2 are illustrated in the flow chart schematically given in FIG. 1.

### EXAMPLE 1

A solution (pulp) on the basis of 17 g of ammonium sulphate with a humidity of 30 wt.-%, a temperature 80° C., pH 1.5, and 29 g ammonia saltpetre with a humidity of 3 wt.-% and a recycle are mixed in the presence of 1.25 g of a substance recalculated for alkaline-earth material. The mixture is granulated at the temperature of 75° C., cooled and classified. As a result, a product with a content of 2.8 wt.-% N, 3.0 wt.-% S0₃ is prepared. The strength σ of the product is not less than 3.0 MPa, pH of the product is not less than 3.5. The concentration of structural compounds is not less than 80 wt.-% from the amount which is theoretically possible.

### EXAMPLE 2

A solution (pulp) based an 17 g of ammonium sulphate with a humidity of 30 wt.-%, a temperature of 85° C., a pH between 7 and 7.5, and 29 g of ammonia saltpetre with a humidity of 3 wt.-%, and recycle are mixed in the presence of a substance of alkaline-earth material comprising at least one alkaline-earth element taken in quantity 1.4 g recalculated for the given element. The mixture is then granulated at a temperature of 65° C. Afterwards, the granulated product is cooled and classified. As a result, a product containing 28 wt.-% N and 2.5 wt.-% to 3.0 wt.-% S0₃ is obtained. The strength σ of the product is not less than 3.0 MPa. Its pH is in the range of 6.5 to 7. The concentration of structural compounds is not less than 87 wt.-% from the amount theoretically possible.

In table 1, an overview an the characteristics of the products and their composition as described in the examples is given.

TABLE 1
Characteristics of the products and their composition as described in examples 1 to 15.

| Example | σ/MPa | pH | C_{N}/wt.-% | C_{P2O5}/wt.-% | C_{K2O}/wt.-% | C_{SO3}/wt.-% | C_{SC}/wt.-% |
|---|---|---|---|---|---|---|---|
| 1 | 3 | 6.5-7 | 28 | — | — | 3 | 80 |
| 2 | 3 | 6.5-7 | 28 | — | — | 3 | 87 |
| 3 | 3 | 5 | 14 | 14 | 14 | — | 93 |
| 4 | 3 | 6 | 10 | 30 | 10 | — | 85 |
| 5 | 3 | 6.5 | 17 | 17 | 17 | — | 90 |
| 6 | 3 | 7 | 17 | 17 | 17 | — | 75 |
| 7 | 3 | =5.5 | 27 | 6 | 6 | — | 75 |
| 8 | 3 | 5.5-6 | 10 | 30 | 10 | — | 90 |
| 9 | 3 | 6 | 15 | 15 | 15 | — | 85 |
| 10 | 3 | 6.5-7 | 10 | 10 | 10 | — | 98 |
| 11 | 3 | =5.5 | 10 | 10 | 30 | — | 83 |
| 12 | 3 | 6 | 15 | 15 | 15 | — | 85 |
| 13 | 3 | 6 | 16 | 16 | 16 | — | 75 |
| 14 | 3 | 5 | 30 | 5 | — | — | 70 |
| 15 | 3 | =5.5 | 15 | 15 | 15 | — | 80 |

The method carried out to realise examples 3 to 6 is illustrated by the schematic flow chart depicted in FIG. 2. The flow chart allows for following the way through all the methods of those examples; the single steps shown in the figure do not necessarily have to be carried out in each of the single methods given as examples.

### EXAMPLE 3

A solution (pulp) based an 16 g of ammonium sulphate with a humidity of 30 wt.-% and a temperature of 80° C. is mixed with 20 g of ammonia phosphate with pH 7. In the next step carried out in example 3, 16.5 g of carbamide and 16 g of potassium chloride are added. In the presence of 1.3 g of compounds of alkaline-earth element recalculated for the taken element, the prepared ingredients are mixed with recycle and granulated at 60° C. The granulated product is then cooled and classified. As a result, the product contains 14 wt.-% N, 14 wt.-% P₂0₅, and 14 wt.-% K₂0. The strength of the product is not less than 3.0 MPa. The pH of a product is 5. The concentration of structural compounds is not less than 93 wt.-% of the amount theoretically possible.

### EXAMPLE 4

39 g of a pulp of ammonium phosphate with pH 5 and a humidity of 23 wt.-% are mixed with 12 g of carbamide, 17 g of potassium chloride, 28 g of ammonium phosphate with pH 4.5 and the recycle. In the presence of compound of alkaline element taken in quantity of 2.4 g recalculated for the taken element, the ingredients are mixed, granulated at the temperature of 55° C., cooled and classified. As a result, the obtained material comprises 10 wt.-% N, 30 wt.-% P₂0₅, and 10 wt.-% K₂0. The strength of the product is not less than 3.0 MPa, the pH of the product is not less than 6.0. The concentration of structural compounds is not less than 85 wt.-% from the amount theoretically possible.

### EXAMPLE 5

12.5 of a pulp of ammonium phosphate with pH 4.5 and a humidity of 20 wt.-% and a temperature of 70° C. are mixed with 8.7 g of carbamide and 8.7 g of potassium chloride and the recycle. In the presence of 0.75 g of a compound of alkaline element recalculated for the taken element, the obtained mixture is granulated at a temperature of 45° C., cooled and classified. As a result, the product contains 17 wt.-% N, 17 wt.-% P₂0₅ and 17 wt.-% K₂0. The strength of the prepared product is not less than 3.0 MPa, the pH of the product is not less than 6.5. The concentration of structural compounds is not less than 90 wt.-% from the amount theoretically possible.

### EXAMPLE 6

A pulp prepared of 31 g of ammonium phosphate with pH 5 and 7.7 g of water, resulting in a humidity of 20 wt.-%, are mixed with 28 g of potassium chloride, 29 g of carbamide and recycle in the presence of a substance containing 2.9 g of alkaline-earth material comprising at least one alkaline-earth element. The obtained mixture is granulated at a temperature of 50° C., cooled and classified. The resulting product contains 17 wt.-% of N, 17 wt.-% of P₂0₅, and 17 wt.-% of K₂O. The strength of the product is not less than 3.0 MPa, and its pH is 7. The quantity of the structural compounds is no less than 75 wt.-% of the amount theoretically possible.

The method carried out to realise examples 7 to 12 is illustrated by the schematic flow chart depicted in FIG. 3. The flow chart allows for following the way through all the methods of those examples; the single steps shown in the figure do not necessarily have to be carried out in each of the single methods given as examples.

### EXAMPLE 7

A quantity of 6 g of ammonium phosphate with pH 4.5 is mixed with sulphuric acid up to pH 1.5. Then, 0.6 g of ammonium sulphate is added. 27 g of ammonia saltpetre with a humidity of 3.5 wt.-% and 13.3 g of ammonia saltpetre solution with a concentration of 85 wt.-% are prepared at the temperature of 80° C. to 85° C. In the presence of substances with alkaline-earth element taken in quantity 0.8 g recalculated for element, the prepared ingredients and recycle are mixed, granulated at the temperature of 70° C., cooled and classified. As a result, the product comprises 27 wt.-% N, 6 wt.-% P205 and 6 wt.-% K₂0. The strength of the product is not less than 3 MPa, pH of the product is not less than 5.5. The concentration of structural compounds is not less than 75 wt.-% from the amount theoretically possible.

### EXAMPLE 8

A quantity of 58 g of ammonium phosphate pH in the range of 4.5 to 5 is mixed with 5.8 g of sulphuric acid. 18 g of a solution of ammonia saltpetre with a concentration of 55 wt.-% to 60 wt.-% are prepared at a temperature of 90° C. In the presence of a compound of alkaline-earth element taken in quantity 2.0 g recalculated for the taken element, the prepared ingredients are mixed with 17 g of potassium chloride and recycle. Then, the mixture is granulated at a temperature of 65° C. As a result, the product comprises 10 wt.-%, N, 30 wt.-% P₂0₅, and 10 wt.-% K₂0. Strength of, the product is not less than 3.0 MPa, pH of the product is 5.5 to 6. The concentration of structural compounds is not less than 90 wt.-% from the amount theoretically possible.

### EXAMPLE 9

A quantity of 10 g of ammonium phosphate with pH 4.5 to 5 is mixed with 1 g of sulphuric acid. Thus, a quantity of 13.3 g of a solution of ammonia saltpetre with a concentration of 85 wt.-% is prepared at a temperature of 75° C. In the presence of 0.6 g of substance of alkaline-earth material comprising at least one alkaline-earth element recalculated for the taken element, the prepared ingredients are mixed with 8.7 g of potassium chloride and recycle. Then, the mixture is granulated at a temperature of 40° C. As a result, a product comprising 15 wt.-% N,. 15 wt.-% P₂0₅, and 15 wt.-% K₂0 is prepared. The strength a of a product is not less than 3.0 MPa, pH of the product is 6. The concentration of structural compounds is not less than 85 wt.-% from the amount theoretically possible.

### EXAMPLE 10

An amount of 58 g of ammonium phosphate with pH 4.5 to 5 is mixed with 5 g of sulphuric acid. Thus, 18 g of a solution of ammonia saltpetre with a concentration of 55 to 60 wt.-% at the temperature of 90° C. are prepared. In the presence of 2.4 g of a compound with alkaline-earth element recalculated for the taken element, the produced ingredients are mixed with 17 g of potassium chloride and recycle. Then, the mixture is granulated at a temperature of 70° C. As a result, a product comprising 10 wt.-% N, 30 wt.-% P₂0₅, and 10 wt.-% K₂0 is prepared. The strength a of the product is not less than 3 MPa, pH of the product is 6.5 to 7. The concentration of structural compounds is not less than 98 wt.-% from the amount theoretically possible.

### EXAMPLE 11

A quantity of 19.2 g of ammonium phosphate with pH of 4.5 to 5 is mixed with 1.9 g of sulphuric acid. 30 g of a solution of ammonia saltpetre and ammonium sulphate with a concentration of 87 wt.-% is prepared at a temperature of 80° C. In the presence of a compound of alkaline-earth element taken in quantity 1.3 g recalculated for the taken element, the prepared ingredients are mixed with 50 g of potassium chloride and recycle. Then, the mixture is granulated at a temperature of 60° C., cooled and classified. As a result, a product comprising 10 wt.-% N, 10 wt.-% P₂0₅, and 30 wt.-% K₂0 is obtained. The strength a of the product is not less than 3.0 MPa, pH of the product is not less than 5.5. The concentration of structural compounds is not less than 83 wt.-% referred to the amount theoretically possible.

### EXAMPLE 12

A solution of ammonium saltpetre is prepared of 11.3 g of ammonium saltpetre, 1 g of ammonium sulphate and 2 g of water. The solution is mixed with 10 g of ammonium phosphate with a pH of 5, 8.6 g of potassium chloride in the presence of a substance containing 0.55 g of alkaline-earth material comprising at least one alkaline-earth element and recycle. The prepared mixture is granulated at a temperature of 60° C., cooled and classified. The resulting product contains 15 wt.-% of N, 15 wt.-% of P₂O₅, and 15 wt.-% of K₂O. The strength σ of the product is no less than 3.0 MPa and its pH is 6. The quantity of the structural compounds is not less than 85 wt.-% of the amount theoretically possible.

The method carried out to realise example 13 is illustrated by the schematic flow chart depicted in FIG. 4.

### EXAMPLE 13

A pulp is prepared from 2.5 g of ammonium phosphate with a pH of 7, 1.6 g of sulphuric acid, 6 g of carbamide, 1 g of ammonium sulphate and 1.5 g of water in presence of a substance containing 0.4.g of alkaline-earth element. The pulp is supplied for mixing with 7.5 g of diammonium phosphate, 7.6 g of potassium chloride and recycle. The material produced is granulated at a temperature of 70° C., cooled and classified. As a result, a product containing 16 wt.-% of N, 16 wt.-% of P₂O₅, and 16 wt.-% K₂0 is prepared. The strength σ of the product is not less than 3.0 MPa, pH of the product is 6. The concentration of the structural compounds is not less than 75 wt.-% of the amount theoretically possible.

The method carried out to realise example 14 is illustrated by the schematic flow chart depicted in FIG. 5.

### EXAMPLE 14

A pulp is prepared of 7.5 g of diammonium phosphate, 2.2 g of sulphuric acid, 1.5 g of sodium chloride, 20 g of ammonium saltpetre, 2.5 g of water and recycle in the presence of substance containing 0.5 g of alkaline-earth element. The pulp is supplied for mixing and granulation with prilled ammonium saltpetre. Encapsulating is performed at a temperature of 75° C. The material produced is cooled and classified. As a result, a product comprising 30 wt.-% of N, and 5 wt.-% of P₂O₅ is obtained. The strength σ of the product is, not less than 3 MPa, its pH is 5. The concentration of the structural compounds is not less than 70 wt.-% of the amount theoretically possible.

The method carried out to realise example 15 is illustrated by the schematic flow chart depicted in FIG. 6.

### EXAMPLE 15

A quantity of 43 g of apatite is decomposed with 62.5 g of nitric acid. The formed calcium nitrate is separated. The produced acidic liquor is ammonised to pH 2.5 to 3.5. Then, in the presence of a substance containing 0.8 g of alkaline-earth element the ammonised acidic liquor is evaporated. In a further step, it is granulated with recycle and 25.4 g of potassium chloride at a temperature of 90° C., cooled and classified. The resulting product comprises 15 wt.-% N, 15 wt.-% P₂O₅, and 15 wt-% K₂O. The strength σ is not less than 3.0 MPa, the pH of the product is not less than 5. The quantity of the structural compounds is not less than 80 wt-% of the amount theoretically possible.

List of Symbols

c concentration
c_{K2O} concentration of K₂O
c_{N} concentration of nitrogen
c_{P2O5} concentration of P₂O₅
c_{SC} concentration of structural compounds
c_{SO3} concentration of SO₃
C cooling rate
M ratio of the mass flow of the recycle referred to the entire mass flow of the product
φ_{S} humidity of a salt
φ_{SP} humidity of a solution and/or pulp
[symbol] temperature
[symbol] _{G} temperature during granulation
σ product's strength=resistance to pressure
t_{M} maturation time

1. A method for producing granular fertilisers having at least one structural compound based on at least one salt, comprising:
disposing of the at least one salt, wherein the at least one salt comprises nitrogen, and wherein the at least one salt is selected from the group consisting of at least one first salt, at least one further salt, and a combination thereof;
humidifying the at least one salt;
producing a mixture by mixing the at least one salt with at least one substance comprising an element selected from the group consisting of an alkaline element, an alkaline-earth element, an element of group IV, and any combinations thereof;
granulating the mixture to produce a granular fertiliser; and
cooling the granular fertiliser.

2. The method according to claim 1, further comprising classifying the granular fertiliser.

3. The method according to claim 2, further comprising feeding at least a part of a fine portion, obtained by classifying, into the method as a recycle.

4. The method according to claim 1, further comprising feeding at least one further salt that comprises nitrogen into the method.

5. The method according to claim 1, wherein the at least one salt comprises a substance selected from the group consisting of ammonium sulphate, ammonium phosphate, diammonium phosphate, ammonium saltpetre, and any combinations thereof.

6. The method according to claim 1, further comprising producing a solution and/or pulp by humidifying the at least one salt.

7. The method according to claim 6, wherein the solution and/or pulp has a concentration c that is at least 40 wt.-%.

8. The method according to claim 7, wherein the concentration c of the solution and/or pulp is in a range of 75 wt.-% ≦c≦95 wt.-%.

9. The method according to claim 6, wherein the solution and/or pulp has a humidity φ_{SP} in a range of 3 wt.-% ≦φ_{SP}≦30 wt.-%.

10. The method according to claim 1, wherein the at least one salt has a humidity φ_{S} that is 10 wt.-%.

11. The method according to claim 6, wherein the solution and/or pulp has a temperature [symbol] _{SP} that is in a range of 75° C.≦ [symbol] _{SP}≦95° C.

12. The method according to claim 6, wherein the solution and/or pulp has a pH that is in the range of 1.5≦pH≦8.

13. A method for producing a granular fertiliser having at least one structural compound based on at least one salt, comprising:
disposing of at least one mineral substance;
decomposing the at least one mineral substance, by precipitation using an acid, forming a precipitate;
separating a remaining acidic liquor from the precipitate;
ammonising the remaining acidic liquor;
producing a mixture by adding at least one substance selected from the group consisting of an alkaline element, an alkaline earth element, an element of group IV, and any combinations thereof, to the ammonised acidic liquor;
evaporating a surplus of moisture;
granulating the mixture to produce a granular fertiliser; and
cooling the granular fertiliser.

14. The method according to claim 13, further comprising classifying the granular fertiliser.

15. The method according to claim 14, further comprising feeding at least a part of a fine portion, obtained by classifying, into the method as a recycle.

16. The method according to claim 13, wherein the at least one mineral substance comprises apatite.

17. The method according to claim 3, wherein the recycle has a ratio M of a mass flow that to an entire mass flow of the granular fertilizer is up to 40 wt.-%.

18. The method according to claim 13, further comprising mixing after adding the at least one substance.

19. The method according to claim 13, further comprising feeding at least one further salt into the method.

20. The method according to claim 19, wherein the at least one further salt is selected from the group consisting of carbamide, potassium chloride, sodium chloride, and any combinations thereof.

21. The method according to claim 19, further comprising mixing after feeding the at least one further salt into the method.

22. The method according to claim 1, wherein during granulating a temperature [symbol] _{G} is in a range of 45° C.≦ [symbol] _{G}≦85° C.

23. The method according to claim 1, further comprising the step of encapsulating a component selected from the group consisting of the granular fertiliser, a further component, and a combination thereof.

24. The method according to claim 23, wherein the further component is a granular component.

25. The method according to claim 23, wherein the step of encapsulating comprises using solutions and/or pulps, that are mixed with the at least one substance, as a coating material.

26. The method according to claim 1, wherein cooling the granular fertilizer is performed at a cooling rate C in the range of 0.1 K min⁻¹≦C≦40 K min⁻¹.

27. The method according to claim 13, wherein at least one mineral acid is fed into the method.

28. The method according to claim 27, wherein the at least one mineral acid is selected from the group consisting of sulphuric acid, phosphoric acid, nitric acid, and any combinations thereof.

29. The method according to claim 27, wherein by feeding the at least one mineral acid into the method obtains a mixture with a pH that is controlled by an amount of the mineral acid added.

30. The method according to claim 1, further comprising feeding water into the method.

31. The method according to claim 1, further comprising adding at least one nutrient.

32. The method according to claim 1, further comprising maturating the granular fertilizer.

33. The method according to claim 32, wherein maturating has a maturation time t_{M} that is to 72 h.

34. Granular fertiliser produced using a method according to claim 1, comprising nitrogen and having a pH in the range of 3≦pH≦7, wherein the granular fertiliser has a strength σ of at least 3 Mpa and an entire amount c_{SC} of at least one structural compound that is at least 50 wt.-%.

35. The granular fertiliser according to claim 34, wherein the structural compound is based on a multiple salt having one further substance.

36. The granular fertiliser according to claim 35, wherein the structural compound is selected from the group consisting of MgHPO₄ n H₂O, NH₄MgPO₄ n H₂O, (NH₄)₂SO₄Mg₂SO₄ n H₂O, NH₄NaHPO₄ n H₂O, and any combinations thereof.

37. The Granular fertiliser according to claim 34, further comprising at least one further component selected from the group consisting of P₂O₅, K₂O, SO₃, and any combinations thereof.

38. The granular fertiliser according to claim 37, further comprising a nitrogen concentration c_{N} in the range of 10 wt.-% ≦c_{N}≦27 wt.-%, a P₂O₅ concentration c_{P2O5} in the range of 6 wt.-% ≦c_{P2O5}≦30 wt.-%, and a K₂O concentration C_{K2O} in the range of 6 wt.-% ≦c_{K2O}≦30 wt-%.

39. The granular fertiliser according to claim 37, further comprising a nitrogen concentration c_{N}=30 wt.-% and a P₂O₅ concentration c_{P2O5}=5 wt-%.

40. The granular fertiliser according to claim 37, further comprising a nitrogen concentration c_{N}=28 wt.-% and a SO₃ concentration c_{SO3}=3 wt.-%.

41. The method according to claim 11, wherein the solution and/or pulp has a temperature [symbol] _{SP} that is in a range of 80° C.≦ [symbol] _{SP}≦85° C.

42. The method according to claim 15, wherein the recycle has a ratio M of a mass flow that to an entire mass flow of the granular fertilizer is up to 40 wt.-%.

43. The method according to claim 22, wherein during granulating a temperature [symbol] _{G} is in a range of 80° C.≦ [symbol] _{G}≦85° C.

44. The method according to claim 13, wherein during granulating a temperature [symbol] _{G} is in a range of 45° C.≦ [symbol] _{G}≦85° C.

45. The method according to claim 44, wherein during granulating a temperature [symbol] _{G} is in a range of 80° C.≦ [symbol] _{G}≦85° C.

46. The method according to claim 24, wherein the further component is selected from the group consisting of prilled ammonium saltpetre, granulated carbamide, and a combination thereof.

47. The method according to claim 13, further comprising the step of encapsulating a component selected from the group consisting of the granular fertiliser, a further component, and a combination thereof.

48. The method according to claim 47, wherein the further component is a granular component.

49. The method according to claim 48, wherein the further component is selected from the group consisting of prilled ammonium saltpetre, granulated carbamide, and a combination thereof.

50. The method according to claim 47, wherein the step of encapsulating comprises using solutions and/or pulps, that are mixed with the at least one substance, as a coating material.

51. The method according to claim 13, wherein cooling the granular fertilizer is performed at a cooling rate C in the range of 0.1 K min⁻¹≦C≦40 K min⁻¹.

52. The method according to claim 13, further comprising feeding water into the method.

53. The method according to claim 13, further comprising adding at least one nutrient.

54. The method according to claim 31, wherein the at least one nutrient is selected from the group consisting of calcium, magnesium, iron, sulphur, boron, zinc, copper, manganese, molybdenum, and any combinations thereof.

55. The method according to claim 53, wherein the at least one nutrient is selected from the group consisting of calcium, magnesium, iron, sulphur, boron, zinc, copper, manganese, molybdenum, and any combinations thereof.

56. The method according to claim 13, further comprising maturating the granular fertilizer.

57. Method according to claim 56, wherein maturating has a maturation time t_{M} that is up to 72 h.

58. The granular fertiliser according to claim 35, wherein the one further substance is water.

59. Granular fertiliser produced using a method according to claim 13, comprising nitrogen and having a pH in the range of 3≦pH≦7, wherein the granular fertiliser has a strength σ of at least 3 Mpa and an entire amount c_{SC} of at least one structural compound that is at least 50 wt.-%.

60. The granular fertiliser according to claim 59, wherein the structural compound is based on a multiple salt having one further substance.

61. The granular fertiliser according to claim 60, wherein the one further substance is water.

62. The granular fertiliser according to claim 60, wherein the structural compound is selected from the group consisting of MgHPO₄ n H₂O, NH₄MgPO₄ n H₂O, (NH₄)₂SO₄Mg₂SO₄ n H₂O, NH₄NaHPO₄ n H₂O, and any combinations thereof.

63. The Granular fertiliser according to claim 59, further comprising at least one further component selected from the group consisting of P₂O₅, K₂O, SO₃, and any combinations thereof.

64. The granular fertiliser according to claim 63, further comprising a nitrogen concentration c_{N} in the range of 10 wt.-% ≦c_{N}≦27 wt.-%, a P₂O₅ concentration c_{P2O5} in the range of 6 wt.-% ≦c_{P2O5}≦30 wt.-%, and a K₂O concentration C_{K2O} in the range of 6 wt.-% ≦c_{K2O}≦30 wt-%.

65. The granular fertiliser according to claim 63, further comprising a nitrogen concentration c_{N}=30 wt.-% and a P₂O₅ concentration c_{P2O5}=5 wt-%.

66. The granular fertiliser according to claim 63, further comprising a nitrogen concentration c_{N}=28 wt.-% and a SO₃ concentration c_{SO3}=3 wt.-%.

67. The method according to claim 12, wherein the pH of the solution and/or pulp is in the range of 4≦pH≦5.

68. The method according to claim 4, wherein the at least one further salt is selected from the group consisting of carbamide, potassium chloride, sodium chloride, and any combinations thereof.

69. The method according to claim 4, further comprising mixing after feeding the at least one further salt into the method.
